(19) United States
(12) Patent Application Publication
(10) Pub. No.: US 2016/0085708 A1
(43) Pub. Date: Mar. 24, 2016

(54) MULTI-LEVEL SCALABLE SWITCH ARCHITECTURE FOR STORAGE APPLIANCE

(71) Applicant: Avalanche Technology, Inc., Fremont, CA (US)

(72) Inventor: Ravishankar TADEPALLI, Fremont, CA (US)

(21) Appl. No.: 14/842,804

(22) Filed: Sep. 1, 2015

Related U.S. Application Data
(60) Provisional application No. 62/044,925, filed on Sep. 2, 2014.

(51) Int. Cl. G06F 13/40; G06F 13/42

(52) U.S. Cl. CPC G06F 13/4022; G06F 13/4282; G06F 13/409

(57) ABSTRACT

A storage appliance device includes an interconnect plane, one or more processor bays, with each processor bay including one or more processor nodes and a front-end switch. The storage appliance device further includes one or more storage bays, with each storage bay including one or more storage cards and one or more back-end switches, the interconnect plane causes communication between the one or more processor bays and the one or more storage bays. The front-end switches and back-end switches cause coupling between the processor bay and the storage cards with interfaces that avoid violation of the requirements of a high-speed transceiver being in communication with the storage appliance device.

### CROSS REFERENCE TO RELATED APPLICATIONS

This application claims priority to U.S. Provisional Patent Application No. 62/044,925, filed on Sep. 2, 2014, by Ravishankar Tadepalli, and entitled “A Multi-Level Scalable Switch Architecture for Storage Appliance Box”.

### BACKGROUND OF THE INVENTION

1. Field of the Invention

The invention relates generally to storage appliances and particularly to reducing routing length for high-speed signals between high-speed transceivers used in storage appliance box.

2. Description of the Prior Art

In a typical storage appliance device, multiple storage cards connect to an interconnect back plane using switch components. The switch components provide switching functionality between a fairly limited number of wide high speed transceiver ports and many narrow high speed transceiver ports.

In many appliances, relatively few wide ports connect to processor nodes and are in physical proximity to processors. From the switch components, many narrow ports traverse long (metal) traces before reaching their destinations, i.e. storage cards. For high-speed links, trace lengths have to be shorter and typically less than 16 inches for reliable data transmission. For links with trace lengths greater than the specified limits or traversing multiple connectors, data transmission between storage cards and a switch complex is unreliable. This oftentimes translates to a storage card being disconnected from the host processor and experience higher error rates during normal operation.

To establish reliable communication, speed of the transceivers is reduced and performance is degraded. In some prior art techniques, retimers or high speed repeaters are used for reliable communications. Retimers and repeaters have to be tuned for equalization and are dependent on the trace length and the number of connectors in the path between the switch component and the storage controller. These retimers and repeaters are at the source as well as the destination.

In a storage appliance device, each storage card can go into any of the slots, therefore, there is a variation in trace lengths extending from the switch component to each of the slots. This technique is applicable in a scenario where the physical location of the transmitter and receiver is deterministic and the transmitter and receiver are tuned during the design phase and do not require tuning during normal operation.

### SUMMARY OF THE INVENTION

Briefly, a storage appliance device includes an interconnect plane, one or more processor bays, with each processor bay including one or more processor nodes and a front-end switch. The storage appliance device further includes one or more storage bays, with each storage bay including one or more storage cards and one or more back-end switches, the interconnect plane causes communication between the one or more processor bays and the one or more storage bays. The front-end switches and back-end switches cause coupling between the processor bay and the storage cards with interfaces that avoid violation of the requirements of a high-speed transceiver being in communication with the storage appliance device.

These and other features of the invention will no doubt become apparent to those skilled in the art after having read the following detailed description of the preferred embodiments illustrated in the several figures of the drawing.

### IN THE DRAWINGS

FIG. 1 shows a block diagram of a storage appliance device with multi-level switch architecture, in accordance with an embodiment of the invention.

FIG. 2 shows an exemplary application of the device 100, in accordance with an embodiment of the invention.

### DETAILED DESCRIPTION OF VARIOUS EMBODIMENTS

In the following description of various embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the present invention. It should be noted that the figures discussed herein are not drawn to scale and thicknesses and number of lines are not indicative of actual sizes or the number of links.

Although the invention has been described in terms of specific embodiments, it is anticipated that alterations and modifications thereof will no doubt become apparent to those more skilled in the art. It is therefore intended that the following claims be interpreted as covering all such alterations and modification as fall within the true spirit and scope of the invention.

To overcome the limitations in the prior art described above, and to overcome other limitations that will become apparent upon reading and understanding the present specification, the invention discloses a method for eliminating the need for longer trace lengths carrying high speed signals and sending the same to storage cards and allows communication between a host processor and the storage cards within the same storage appliance device and further allows communication between the host processor and the storage cards in a different storage appliance device.

Several advantages of the various embodiments of the invention are evident to those skilled in the art after having read the following detailed description of the embodiments illustrated in the several figures of the drawing. The inventions described in the following figures can be extended to further splitting of the back-end switches and front-end switches depending on the capabilities of the switch components, or to components with multiple functionality of switching between controllers communicating with the same protocol and bridging between components communicating with different protocols.

The requirement is a scheme for reliable and high performance operation between the host processor and the storage cards where the storage cards are physically located within the same storage appliance device or located in a different storage appliance device.

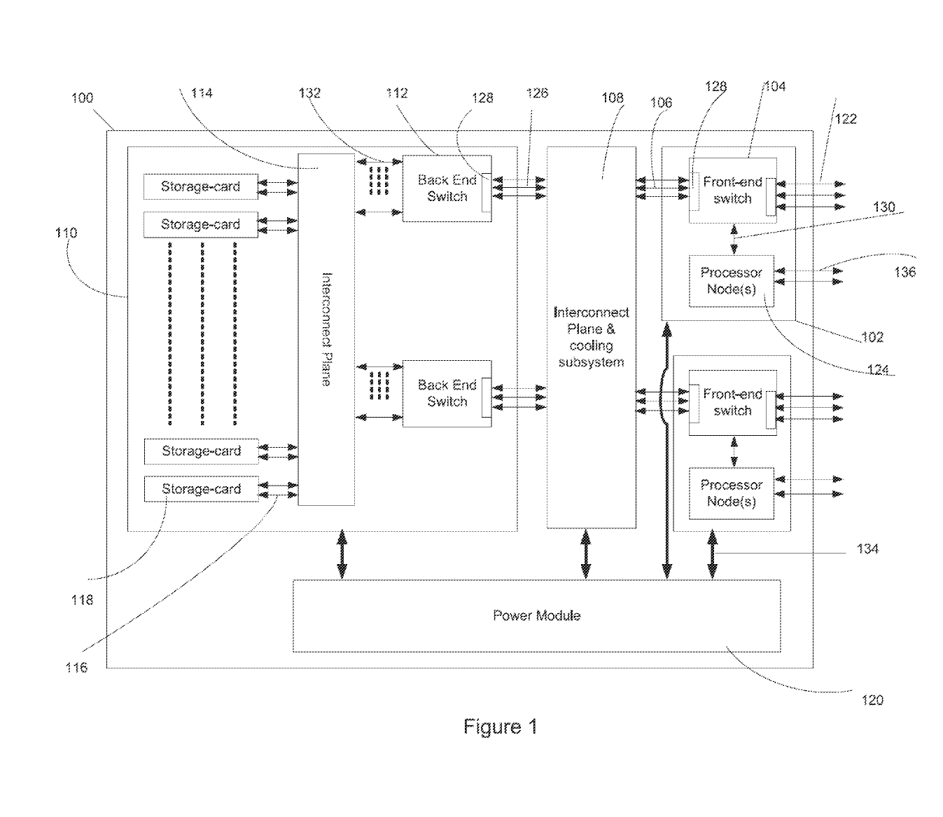

Referring now to FIG. 1, a storage appliance device 100 is shown in accordance with an embodiment of the invention to include one or more processor bays 102, storage bay 110, power module 120, and interconnect plane and cooling subsystem 108. Processor bay(s) 102 and storage bay 110 are coupled to each other through the integrated interconnect plane 108. The physical location for interconnect plane 108 may also include a cooling subsystem like fans based on other design parameters like efficient air flow and audible noise from fans.

The storage bay 110 is shown to include one or more storage cards 118, an interconnect plane 114, and one or more back-end switches 112. Each processor bay 102 is shown to include a front-end switch 104 and one or more processor nodes 124. The interconnect plane and cooling subsystem is shown to communicate with the front-end switches 104 of the processor bay 102 and the back-end switches 112 of the storage bay storage bay 110. It is also coupled to the power module 120. The power module 120 provides power to the storage bay 110 as well as the subsystem 108.

Within the storage bay 110, the storage cards 118 are shown coupled to the interconnect plane 114 and the interconnect plane 114 is shown coupled to the back-end switches 112. Within each of the power module 120, the front-end switch is shown coupled to the one or more processor nodes 124. Each of the front-end switches 104 of the processor bay 102 is shown to communicate with the subsystem 108 through its retimer 128 and the interface 106 and the back-end switches 112 are shown to communicate with the subsystem 108 through their retimers 128 and the interface 126.

In the true spirit of the invention, each processor node 124 includes one or more central processing units (CPUs), hardware accelerator engines or another multi-level switch with inputs from another appliance device. Front-end switch element 104 communicates with processor nodes 124, external appliance box on the interface 122 and to the interconnect plane 108 on the interface 106. In the true spirit of the current invention, links 122 include but not limited to retimers and network adapters. Interconnect plane 108 provides routing tracks to the storage bay 110. Since only one component exists between each of the front-end switch 104 and their corresponding back-end switches 112, i.e. the interconnect plane 108, which is a passive element, the distance between the front-end switches 104 and the back-end switches 112 can be restricted to be within the limits of a high-speed transceiver's requirement without limitations to the functionality of either the switches 104 or the switches 112.

The storage bay 110 is shown to include one or more backend switch elements 112, local interconnect plane 114 and an array of storage cards 118. In a highly available storage bay, multiple backend switches 112 communicate with storage cards of narrow high speed links 116. Thus, there is a separate high-speed link from each of the backend switches 112 to each of the storage cards 118.

Multiple sets of interfaces (or “interconnect trace elements”) 106, 126, 132, and 116 form various segments of the links from the front-end switch elements 122 to storage cards 118. Interconnect trace segments 106 and 126 are either localized between front-end switch element 104 and back-end switch element 112 or retimed using retimers 128. Interconnect trace segments 132 and 116 are localized between back-end switch element 112 and storage card element 118. Since all the components are localized to storage bay, variations in physical trace length of high speed segments 116 and 132 can be limited to the requirements of high speed transceivers without limiting the functionality and reliability and without using retimers on the interfaces 132 and 116.

Since the storage add-on cards 118 are missing retimers on either end of the interfaces 132 and 116, the cards 118 can be placed in any slot of the storage bay 110. In a single storage appliance device with integrated storage bay 110 and processor bay 102, trace lengths from front-end switches 104 to storage cards 118 are split into multiple segments (or “interfaces”), i.e. segments 116, 132, 126 and 106. Segments 106 are 126 are either localized or retimed, segments 132 and 116 are localized to the storage bay 110 without any retimers. With segmentation of the trace length and appropriate placements of retimers, all segments are within the limits of high-speed transceiver's requirements providing reliable and high-speed communications between all the processor nodes 124 and all storage add-on cards 118 without the need for retuning or disruptions to communication links during normal operation in a highly-available (high availability (HA)) storage appliance device.

Because the physical locations of back-end switch 110 and front-end switch 104 are deterministic, optionally retimers 128 can be resident in the segment 126, which is generally a high-speed wide link due to the subsystem's 108 design considerations and the application requirements of the storage bay 110.

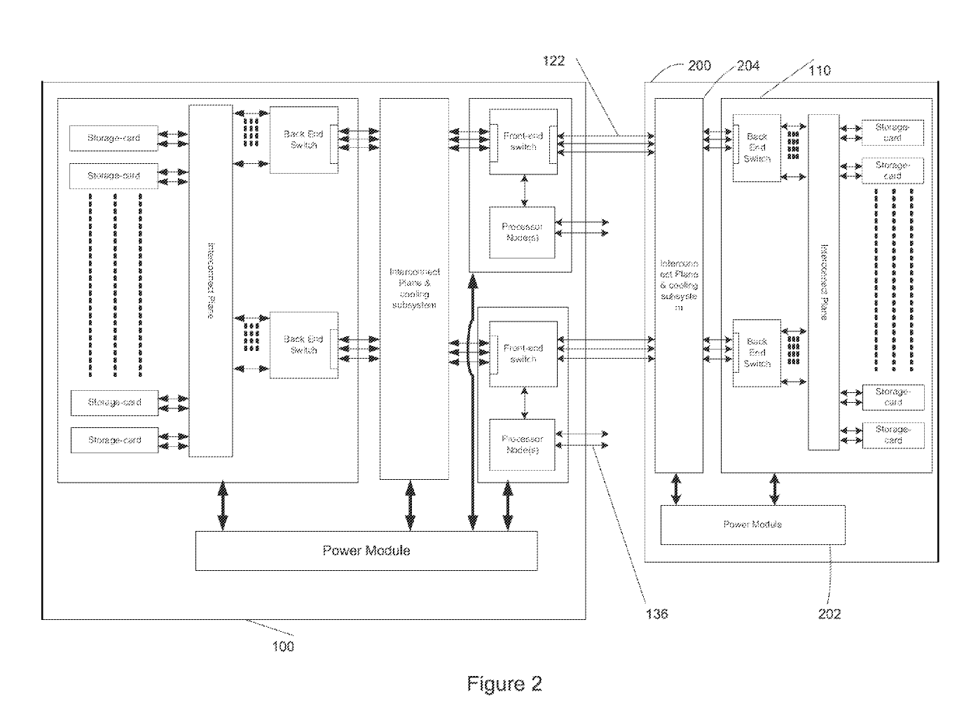

FIG. 2 shows an exemplary application of the device 100, in accordance with an embodiment of the invention. The appliance device 100 is shown coupled to a standalone storage bay 200 for increased functionality. Standalone storage bay 200 is shown to include the storage bay 110 of FIG. 1 and a power module 202. Standalone storage bay 200 is shown coupled to storage appliance device 100 through retimers 128 located on either end of the segments 122, which are high-speed links, through high-speed cables. Any variations in the configuration of integrated storage bay 110 and processor bay 102 integrated into the standalone storage bay 200 are considered to be part of the invention. Any variations in the number of links and configuration of interconnect links (“interfaces” or “segments”) between multiple standalone storage bay 200 coupling with the multiple appliance devices 100 are also considered as part of invention.

It is noted that the storage cards 118 are typically many is most applications. Each of the processor nodes 124 includes a processor and the device 100 communicates with a transceiver that has certain speed and noise requirements, generally no met by current techniques but that due to the interfaces 116, 132, 126 and 106 being short relative to prior art techniques, such requirements are not violated.

Although the invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claimed is:

1. A storage appliance device comprising:
an interconnect plane;
one or more processor bays, each processor bay including one or more processor nodes and a front-end switch;
one or more storage bays, each storage bay including one or more storage cards and one or more back-end switches, the interconnect plane causing communication between the one or more processor bays and the one or more storage bays, the front-end switches and back-end switches causing coupling between the processor bay and the storage cards with interfaces that avoid violation of the requirements of the high speed transceivers.
